(19) United States
(12) Patent Application Publication
(10) Pub. No.: US 2023/0115778 A1
(43) Pub. Date: Apr. 13, 2023

(54) SYSTEMS AND METHODS FOR CONTROLLING AGRICULTURAL MATERIAL UNLOADING RATE

(71) Applicant: J. & M. Manufacturing Co., Inc., Ft. Recovery, OH (US)

(72) Inventors: Sean Kahlig, Ft. Recovery, OH (US); Dustan Grieshop, Ft. Recovery, OH (US); Mitch Wood, Ft. Recovery, OH (US)

(21) Appl. No.: 17/495,981

(22) Filed: Oct. 7, 2021

(51) Int. Cl. A01D 90/14; A01D 90/10

(52) U.S. Cl. CPC A01D 90/14; A01D 90/10

(57) ABSTRACT

A device for controlling the rate at which agricultural material is unloaded from a supplying container includes a metering gate configured to control the flow of agricultural material from the supplying container to a transfer element. An actuator is coupled to the metering gate and moves the metering gate between an open position and a closed position. A sensor is configured to detect an operational input. An electronic control device is coupled to the sensor and the actuator. The sensor provides an operational input to the electronic control device. The electronic control device is configured to direct the operation of the actuator. The directed operation of the actuator is based at least in part on the operational input. The transfer element is configured to transfer agricultural material from the supplying container to a receiving container.

### TECHNICAL FIELD

The present disclosure generally relates to devices for agricultural harvesting equipment and, more particularly, to systems for transferring agricultural material, and related methods.

### BACKGROUND

Harvesting operations for some agricultural materials, such as corn, wheat, soybeans or the like, may involve transferring harvested agricultural material into containers for transport. For example, a combine harvester may separate the agricultural material from the other portions of the plant and may discharge the harvested agricultural material into a grain cart, which may be used to transport the agricultural material across a field, such as to a road, where the grain cart is unloaded into a tractor-trailer for transport via roads. In another example, a combine harvester may separate soybeans from their pods and other portions of the plant and may discharge the harvested soybeans into a grain cart. It should be understood that the term “grain” is used herein as referring to agricultural material independent of how that material is strictly defined by the USDA or other reference materials.

Transferring agricultural material, may at times be a labor-intensive operation. An operator may be required to monitor and control the transfer process to avoid spillage, for example. Typically, transfer operations, such as transferring agricultural material from a grain cart into a tractor-trailer for example, have the potential to spill agricultural material, such as by overflowing the receiving container or misaligning the discharge stream of the unloading equipment relative to the receiving container. When transfer equipment is operated at a high transfer rate, even a very brief overflow or misalignment may be significantly costly as a large amount of agricultural material may be spilled in a short period of time. As agricultural material is transferred from a grain cart to a tractor-trailer, for example, an operator may need to realign the grain cart in relation to the tractor-trailer to ensure even filling of the tractor-trailer and avoid overfilling portions of the tractor-trailer.

Grain carts equipped with augers for unloading agricultural material may have a wide range of speeds at which they can transfer material from the grain cart to a transport container. Grain cart augers are typically driven by a power take off shaft of a tractor. As tractors and grain carts increase in size and power, including the size of the grain cart augers, the speed at which agricultural material may be unloaded can easily become unmanageable for some operators.

Some grain carts employ systems to stop the unloading of agricultural materials once a predetermined weight of agricultural material has been unloaded. Some grain carts include systems that ensure unloading occurs only when the transfer device, an auger for example, is rotating above a minimum rotational speed to minimize the internal stresses on the unloading system. However, these systems do not limit the maximum speed at which the agricultural material can be unloaded potentially creating challenges for some operators.

Accordingly, and in spite of the various advances already made in this field, there is a need for further improvements related to systems and methods for transferring harvested agricultural material into transport containers.

### SUMMARY

Generally, a device for controlling the rate at which agricultural material is unloaded from a supplying container is provided, the device comprising a metering gate configured to control the flow of agricultural material from the supplying container to a transfer element, an actuator operatively coupled to the metering gate and moving the metering gate between an open position and a closed position, a sensor configured to detect a position of the metering gate, and an electronic control device operatively coupled to the sensor and the actuator. A maximum open position of the metering gate may be programed into the electronic control device. The sensor provides an operational input to the electronic control device. The electronic control device is configured to direct the operation of the actuator. The directed operation of the actuator is based at least in part on the programed maximum open position of the metering gate and the position of the metering gate. The transfer element is configured to transfer agricultural material from the supplying container to a receiving container.

In alternative or additional aspects, the electronic control device may monitor the position of the metering gate and control the position of the metering gate to limit the position of the metering gate at or below the programed maximum open position. The electronic control device may include a plurality of pre-programed metering gate maximum open positions. At least one of the pre-programed metering gate maximum open positions may be selected, the electronic control device may monitor the position of the metering gate, and the electronic control device may control the position of the metering gate to limit the position of the metering gate at or below the programed maximum open position.

In some embodiments, a device for controlling the rate at which agricultural material is unloaded from a supplying container may comprise a metering gate configured to control the flow of agricultural material from the supplying container to a transfer element, an actuator for positioning the metering gate operatively coupled to the metering gate and moving the metering gate between an open position and a closed position, a sensor configured to detect the position of the metering gate, and an electronic control device operatively coupled to the sensor and the actuator. A maximum transfer rate may be programed into the electronic control device. The sensor may provide an operational input to the electronic control device. The electronic control device may be configured to direct the operation of the actuator. The directed operation of the actuator may be based at least in part on the programed maximum transfer rate and the position of the metering gate. The transfer element may be configured to transfer agricultural material from the supplying container to a receiving container.

In alternative or additional aspects, the electronic control device may monitor the position of the metering gate and control the position of the metering gate to maintain the unload rate at or below the maximum transfer rate. The electronic control device may include a plurality of pre-programed maximum transfer rates. One of the pre-programed maximum transfer rates may be selected, the electronic control device may monitor the position of the metering gate, and the electronic control device may control the position of the metering gate to maintain the unload rate at or below the programed maximum transfer rate.

In alternative or additional aspects, the electronic control device may comprise a cleanout mode. When the device is in cleanout mode the electronic control device may control the position of the metering gate and position the metering gate in a fully open position to facilitate the removal of agricultural material from the supplying container.

In alternative or additional aspects, the device may further comprise a user interface operatively coupled to the electronic control device. The user interface may be operative to allow a user to program an operational input into the electronic control device. The user interface may comprise a graphical user interface. The user interface may be wirelessly coupled to the electronic control device.

In some embodiments, the actuator may comprise a hydraulic cylinder. The hydraulic cylinder may further comprise the sensor. In some embodiments, a device for controlling the rate at which agricultural material is unloaded from a supplying container may include a hydraulic valve. The electronic control device may be configured to control a hydraulic valve and the hydraulic valve may be configured to control the flow of hydraulic fluid to the hydraulic cylinder to control the position of the metering gate. In alternative embodiments, the actuator may comprise an electric linear actuator, and the actuator may further comprise the sensor. In some embodiments, the actuator may comprise a hydraulic linear actuator, and the actuator may further comprise the sensor.

In alternative or additional aspects, the sensor may comprise a linear position sensor. The sensor may comprise a time-of-flight sensor. The sensor may comprise a pressure transducer. The sensor may comprise a plurality of proximity sensors.

In some embodiments, the device may further comprise a sensor configured to detect a torque applied to the transfer element and coupled to the electronic control device. The sensor may provide an operational input to the electronic control device. The directed operation of the actuator may be based at least in part on the torque applied to the transfer element. The electronic control device may control the position of the metering gate to limit the torque applied to the transfer element below a maximum torque. A maximum torque value may be programed into the electronic control device. The electronic control device may include a plurality of pre-programed maximum torque values. One of the pre-programed maximum torque values may be selected. The electronic control device may monitor the torque applied to the transfer element. The electronic control device may control the position of the metering gate to limit the torque applied to the transfer element at or below the programed maximum torque value. The electronic control device may close the metering gate if the detected torque is below a minimum torque value. The electronic control device may provide a perceptible indication that the metering gate has been closed. The perceptible indication could be an audible alarm, for example. The perceptible indication could be an indicator light, for example. The perceptible indication could be a message on a graphical user interface, for example.

In alternative or additional aspects, the device may further comprise a sensor configured to detect a rotational speed of the transfer element and coupled to the electronic control device. The sensor may provide an operational input to the electronic control device. The directed operation of the actuator may be based at least in part on the rotational speed of the transfer element. The electronic control device may control the position of the metering gate to maintain a minimum rotational speed of the transfer element. A minimum rotational speed value may be programed into the electronic control device. The electronic control device may include a plurality of pre-programed minimum rotational speed values. One of the pre-programed minimum rotational speed values may be selected. The electronic control device may monitor the rotational speed of the transfer element. The electronic control device may control the position of the metering gate to maintain the rotational speed of the transfer element at or above the programed minimum rotational speed. The electronic control device may close the metering gate if the detected rotational speed is zero. The electronic control device may provide a perceptible indication that the metering gate has been closed. The electronic control device may be configured to not open the metering gate if the detected rotational speed is below a minimum value. The electronic control device may provide a perceptible indication that the metering gate electronic control device will not open the metering gate due to low rotational speed. The perceptible indication could be an audible alarm, for example. The perceptible indication could be an indicator light, for example. The perceptible indication could be message on a graphical user interface, for example.

In some embodiments, the device may further comprise a sensor configured to detect a horsepower applied to the transfer element and coupled to the electronic control device. The sensor may provide an operational input to the electronic control device. The directed operation of the actuator may be based at least in part on the horsepower applied to the transfer element. The electronic control device may control the position of the metering gate to control the horsepower applied to the transfer element. A maximum horsepower value may be programed into the electronic control device. The electronic control device may include a plurality of pre-programed horsepower values. One of the pre-programed maximum horsepower values may be selected. The electronic control device may monitor the horsepower applied to the transfer element. The electronic control device may control the position of the metering gate to control the horsepower applied to the transfer element at or below the programed maximum horsepower value.

In some embodiments, a device for controlling the rate at which agricultural material is unloaded from a supplying container may include a metering gate configured to control the flow of agricultural material from the supplying container to a transfer element, an actuator coupled to the metering gate and moving the metering gate between an open position and a closed position, a sensor configured to detect the position of the metering gate, and an electronic control device coupled to the sensor and the actuator. A transfer rate may be programed into the electronic control device. The sensor may provide an operational input to the electronic control device. The electronic control device may be configured to direct the operation of the actuator. The directed operation of the actuator may be based at least in part on the programed transfer rate and the position of the metering gate. The transfer element may be configured to transfer agricultural material from the supplying container to a receiving container. The electronic control device may monitor the position of the metering gate. The electronic control device may control the position of the metering gate to maintain the unload rate at or near the programed transfer rate.

In alternate embodiments, a device for controlling the rate at which agricultural material is unloaded from a supplying container may include a metering gate configured to control the flow of agricultural material from the supplying container to a transfer element, an actuator coupled to the metering gate and moving the metering gate between an open position and a closed position, a sensor configured to detect a torque applied to the transfer element, and an electronic control device coupled to the sensor and the actuator. A transfer rate may be programed into the electronic control device. The sensor may provide an operational input to the electronic control device. The electronic control device may be configured to direct the operation of the actuator. The directed operation of the actuator may be based at least in part on the programed transfer rate and the torque applied to the transfer element. The transfer element may be configured to transfer agricultural material from the supplying container to a receiving container. The electronic control device may monitor the torque applied to the transfer element. The electronic control device may control the position of the metering gate to maintain the unload rate at or near the programed transfer rate.

In some embodiments, a device for controlling the rate at which agricultural material is unloaded from a supplying container may include a metering gate configured to control the flow of agricultural material from the supplying container to a transfer element, an actuator coupled to the metering gate and moving the metering gate between an open position and a closed position, a sensor configured to detect a speed of the transfer element, and an electronic control device coupled to the sensor and the actuator. A transfer rate may be programed into the electronic control device. The sensor may provide an operational input to the electronic control device. The electronic control device may be configured to direct the operation of the actuator. The directed operation of the actuator may be based at least in part on the programed transfer rate and the speed of the transfer element. The transfer element may be configured to transfer agricultural material from the supplying container to a receiving container. The electronic control device may monitor the speed of the transfer element. The electronic control device may control the position of the metering gate to maintain the unload rate at or near the programed transfer rate.

In some embodiments, a device for controlling the rate at which agricultural material is unloaded from a supplying container may include a metering gate configured to control the flow of agricultural material from the supplying container to a transfer element, an actuator coupled to the metering gate and moving the metering gate between an open position and a closed position, a weigh scale configured to detect a weight of agricultural material in the supplying container, and an electronic control device coupled to the sensor and the actuator. A transfer rate may be programed into the electronic control device. The weigh scale may provide an operational input to the electronic control device. The electronic control device may be configured to direct the operation of the actuator. The directed operation of the actuator may be based at least in part on the programed transfer rate and the weight of the agricultural material in the supplying container. The transfer element may be configured to transfer agricultural material from the supplying container to a receiving container. The electronic control device may monitor the weight of the agricultural material in the supplying container. The electronic control device may control the position of the metering gate to maintain the unload rate at or near the programed transfer rate.

In alternate embodiments, a device for controlling the rate at which agricultural material is unloaded from a supplying container may include a metering gate configured to control the flow of agricultural material from the supplying container to a transfer element, an actuator coupled to the metering gate and moving the metering gate between an open position and a closed position, a sensor configured to detect a horsepower applied to the transfer element, and an electronic control device coupled to the sensor and the actuator. A transfer rate may be programed into the electronic control device. The sensor may provide an operational input to the electronic control device. The electronic control device may be configured to direct the operation of the actuator. The directed operation of the actuator may be based at least in part on the programed transfer rate and the horsepower applied to the transfer element. The transfer element may be configured to transfer agricultural material from the supplying container to a receiving container. The electronic control device may monitor the horsepower applied to the transfer element. The electronic control device may control the position of the metering gate to maintain the unload rate at or near the programed transfer rate.

A method of operating a gate positioning system is provided, the method comprising programing a maximum metering gate open position into an electronic control device, operating a transfer element, opening a metering gate, providing information on an open state of the metering gate to the electronic control device, and preventing the metering gate from opening past the programed maximum metering gate open position. The method may further comprise changing the maximum metering gate open position during an unload operation. Programing a maximum metering gate open position may comprise selecting a maximum metering gate open position from a plurality of preprogramed metering gate open positions. The method may further comprise changing the maximum metering gate open position during an unload operation by selecting a new maximum metering gate open position from a plurality of preprogramed metering gate open positions.

In alternative or additional aspects, programing a maximum metering gate open position may comprise programing a maximum unloading rate. The method may further comprise determining the metering gate position required to achieve the maximum unloading rate. Programing a maximum unloading rate may comprise selecting an unload rate from a plurality of preprogramed unload rates. The method may further comprise changing a maximum unloading rate during an unload operation by selecting an unload rate from a plurality of preset unload rates. The method may further comprise performing a cleanout by positioning the metering gate in a fully open position. The method may further comprise closing the metering gate. The method may further comprise coupling a grain cart to a tractor, coupling a power and hydraulic lines between the grain cart and the tractor.

A method of manufacturing a gate positioning system is provided, the method comprising installing a metering gate on a supplying container, the metering gate may be configured to be positioned to control the flow of agricultural material from the supplying container to a transfer element, installing an actuator for positioning the metering gate, the actuator may be operatively coupled to the metering gate, installing a sensor configured to detect the position of the metering gate, and installing an electronic control device operatively coupled to the sensor and the actuator. The electronic control device may be configured for programing a maximum open position of the metering gate. The electronic control device may be configured to direct the operation of the actuator. The directed operation of the actuator may be based at least in part on the programed maximum open position of the metering gate and the position of the metering gate. The transfer element may be configured to transfer agricultural material from the supplying container to a receiving container.

Another method of manufacturing a gate positioning system may comprise installing a metering gate on a supplying container, the metering gate may be configured to be positioned to control the flow of agricultural material from the supplying container to a transfer element, installing an actuator for positioning the metering gate, the actuator may be operatively coupled to the metering gate, installing a sensor configured to detect the position of the metering gate, and installing an electronic control device operatively coupled to the sensor and the actuator. The electronic control device may be configured for programing a maximum transfer rate. The electronic control device may be configured to direct the operation of the actuator. The directed operation of the actuator may be based at least in part on the programed maximum transfer rate and the position of the metering gate. The transfer element may be configured to transfer agricultural material from the supplying container to a receiving container.

In some embodiments, a device for controlling the rate at which agricultural material is unloaded from a supplying container may include a metering gate configured to control the flow of agricultural material from the supplying container to a transfer element, an actuator coupled to the metering gate and moving the metering gate between an open position and a closed position, a sensor configured to detect an operational input, and an electronic control device coupled to the sensor and the actuator. The sensor may provide an operational input to the electronic control device. The electronic control device may be configured to direct the operation of the actuator. The directed operation of the actuator may be based at least in part on the operational input. The transfer element may be configured to transfer agricultural material from the supplying container to a receiving container. The sensor may comprise a sensor configured to detect a position of the metering gate. The sensor may comprise a sensor configured to detect a torque applied to the transfer element. The sensor may comprise a sensor configured to detect a rotational speed of the transfer element. The sensor may comprise a sensor configured to detect a horsepower applied to the transfer element. The sensor may comprise a weigh scale configured to detect a weight of agricultural material in the supplying container. The operational input may be as summarized and/or specifically discussed herein, or may be another operational input as desired.

Another method of operating a gate positioning system may include operating a transfer element at a desired unloading rate utilizing an electronic control device that directs the operation of an actuator coupled to a metering gate and a sensor providing an operational input to the electronic control device. Controlling the position of the metering gate to control a flow of agricultural material from a supplying container to a transfer element. Maintaining the unloading rate at or near the desired unloading rate based at least in part on the operational input. The method may further comprise determining a metering gate position required to maintain the desired unloading rate. The method may further comprise determining a required torque applied to the transfer element to maintain the desired unloading rate. The method may further comprise determining a required rotational speed of the transfer element to maintain the desired unloading rate. The method may further comprise determining a required horsepower applied to the transfer element to maintain the desired unloading rate. The method may further comprise monitoring a weight of agricultural material in the supplying container to maintain the desired unloading rate. The operational input may be as summarized and/or specifically discussed herein, or may be another operational input as desired.

Additional aspects and advantages of the invention will become more apparent upon further review of the detailed description of the illustrative embodiments taken in conjunction with the accompanying drawings.

### BRIEF DESCRIPTION OF THE DRAWINGS

FIG. 1 is a perspective view of an illustrative grain cart transferring harvested agricultural material to a tractor-trailer.

FIG. 2 is a side elevation view of the illustrative grain cart of FIG. 1.

FIG. 3 is a sectional view of the illustrative grain cart of FIG. 2 with a metering gate in a closed position.

FIG. 4 is a sectional view of the illustrative grain cart of FIGS. 2 and 3 with the metering gate in at least a partially open position.

FIG. 5 is a simplified block diagram of an exemplary gate positioning system.

FIG. 6 is an illustration of an exemplary graphical user interface.

### DETAILED DESCRIPTION

Illustrative embodiments according to at least some aspects of the present disclosure are described and illustrated below and include devices and methods relating to transferring harvested agricultural materials, such as corn, wheat, soybeans or the like, into transport containers. It will be apparent to those of ordinary skill in the art that the embodiments discussed below are examples and may be reconfigured without departing from the scope and spirit of the present disclosure. It is also to be understood that variations of the exemplary embodiments contemplated by one of ordinary skill in the art shall concurrently comprise part of the instant disclosure. The illustrative embodiments as discussed below may include optional steps, methods, and features that one of ordinary skill should recognize as not being a requisite to fall within the scope of the present disclosure.

When introducing elements various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure includes, among other things, systems for transferring harvested agricultural material into transport containers, and related methods. Agricultural material may include corn, wheat, rice, soybeans, and the like. Although the generic term grain is mentioned below in illustrative examples, it should be appreciated that similar systems and methods may be utilized in connection with any agricultural materials that, in the aggregate, may have fluid flow like properties. Some illustrative embodiments according to at least some aspects of the present disclosure are described below in the context of a grain cart and operations involving transferring grain from the grain cart to another container. It will be appreciated, however, that similar systems and methods may be utilized in connection with other agricultural equipment and containers. As used herein, “transport container” may refer to any device configured to hold harvested agricultural materials during movement from one location to another location. Exemplary transport containers may include various types of agricultural equipment, such as grain carts, grain bins, gravity wagons, grain tanks, grain hopper trailers for tractor-trailers, and the like. Transport containers may also include railcars configured to haul grain, barge or ship holds configured to haul grain, and the like. As used herein, “supplying container” may refer to a container from which grain is transferred and “receiving container” may refer to a container into which grain is transferred.

General advantages of the disclosed system for transferring harvested agricultural material into transport containers include making the grain cart more user friendly by providing better control of the unloading rate, and providing safeguards to protect the drive train of the unloading mechanism (auger, motor, gears etc.).

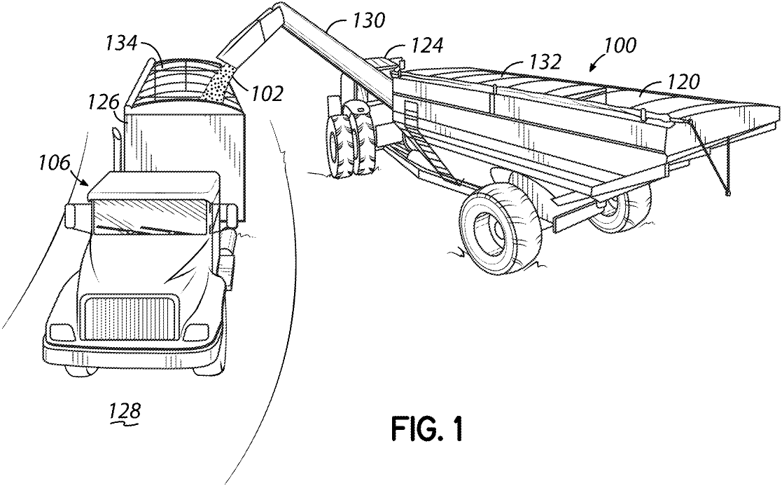

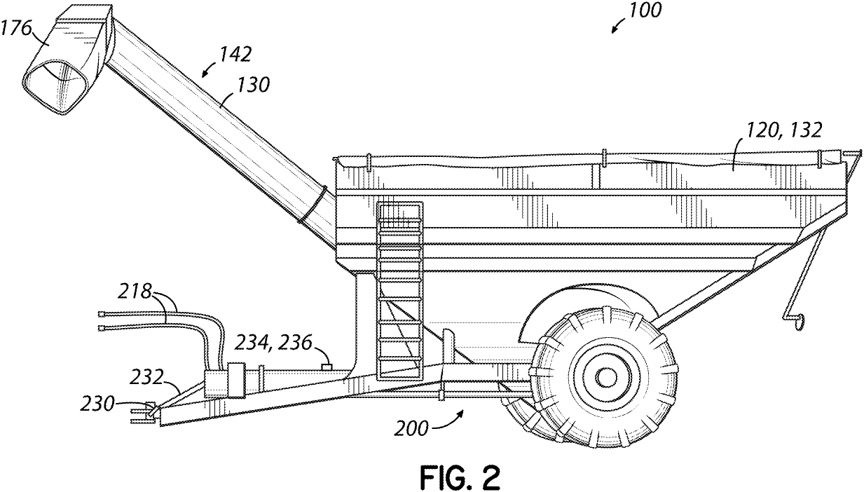

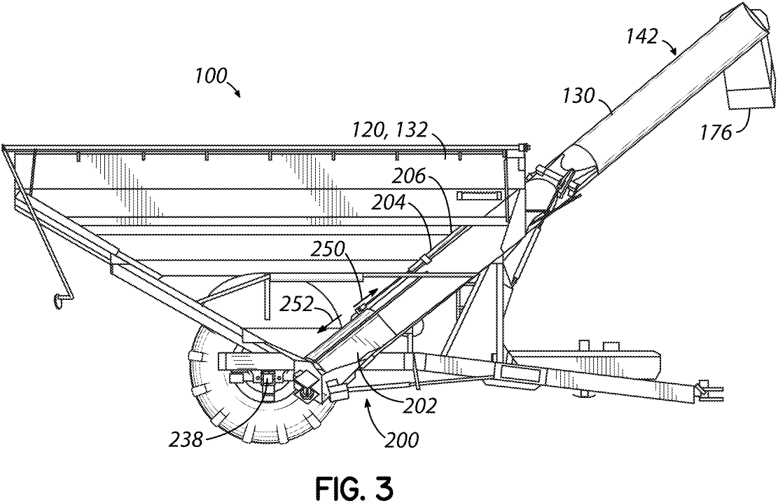

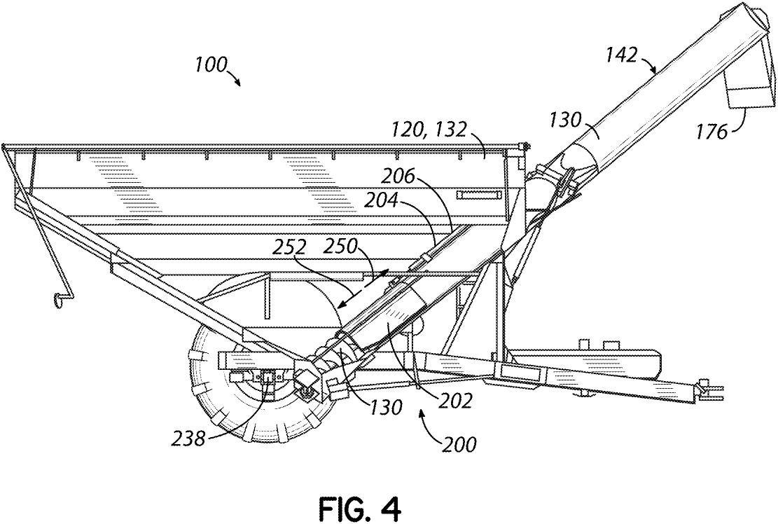

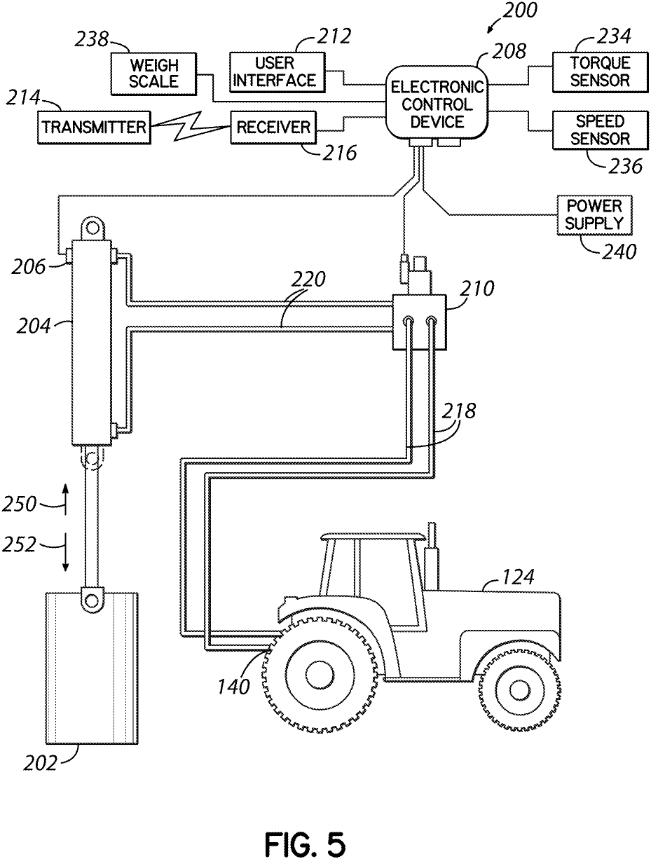

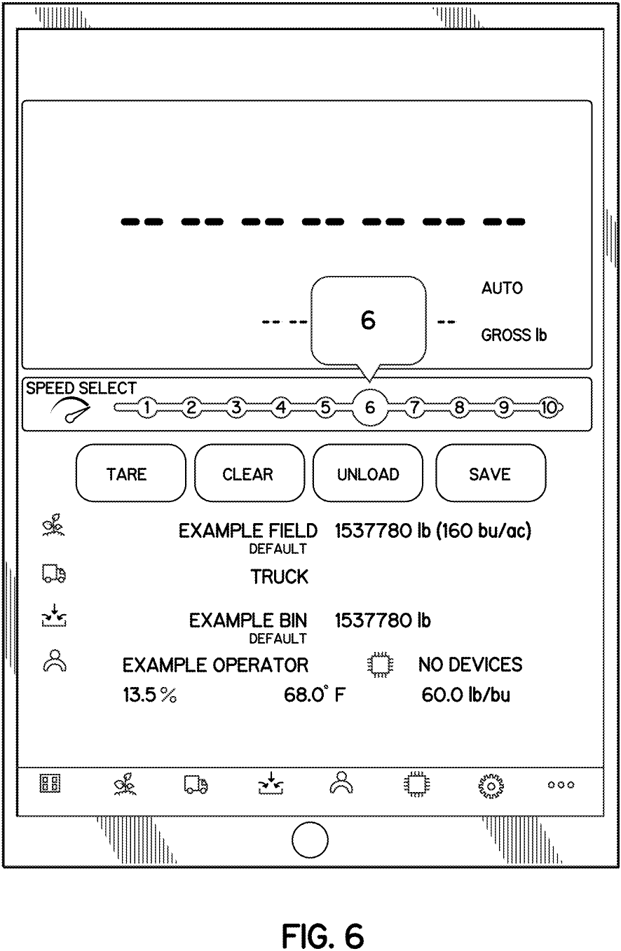

FIG. 1 is a perspective view of an illustrative grain cart transferring harvested grain to a tractor-trailer. FIG. 2 is a side elevation view of the illustrative grain cart. FIG. 3 is a sectional view of the illustrative grain cart of FIG. 2 with a metering gate in a closed position. FIG. 4 is a sectional view of the illustrative grain cart of FIGS. 2 and 3 with a metering gate in at least a partially open position. FIG. 5 is a simplified block diagram of an exemplary metering gate system. FIG. 6 is an illustration of an exemplary graphical user interface.

Referring to FIG. 1, the grain 102 in the grain cart 100 is transferred (e.g., unloaded) into a grain hopper trailer 126 of a tractor-trailer 106, which may be located on or near a road 128. The grain cart 100 includes a rotatable transfer element 130, such as an auger, which is configured to transfer the grain 102 from the grain cart grain tank 120 to a grain hopper trailer 126, for example. The tractor-trailer 106 may then transport the harvested grain 102 via the road 128, for example.

Referring to FIGS. 1-5, the illustrative grain cart 100 comprises a gate positioning system 200, which is configured to operate in connection with transferring grain 102 from the grain cart grain tank 120. Generally, the gate positioning system 200 is configured to assist with the transfer rate of the grain 102 from the grain cart 100 to a transport container, such as the grain hopper trailer 126, thereby reducing the likelihood of spilling the grain 102, for example.

In this exemplary embodiment, the gate positioning system 200 allows a user to control the rate at which grain 102 is unloaded from a supplying container 132, such as a grain cart grain tank 120. The gate positioning system 200 comprises a metering gate 202, an actuator 204, a sensor 206, and an electronic control device 208. The metering gate 202 is configured to be positioned to control the flow of grain 102 from the gain cart grain tank 120 to a transfer element 130. The position of the metering gate 202 controls the flow of the grain 102 going to the transfer element 130. The transfer element 130 is configured to transfer the grain 102 from a supplying container 132 to a receiving container 134. In this illustrative embodiment, the transfer element 130 is an auger. In some embodiments, the transfer element 130 may be a belt, for example. In alternate embodiments, the transfer element 130 may be a drag chain, for example. The transfer element 130 may be a combination of elements configured to transfer the grain 102 from a supplying container 132 to a receiving container 134.

In this illustrative embodiment, the actuator 204 is operatively coupled to the metering gate 202 and is configured to position the metering gate 202 between an open position and a closed position. The sensor 206 is configured to detect the position of the metering gate 202. The sensor 206 is operatively coupled to the electronic control device 208. The sensor 206 provides an operational input to the electronic control device 208 based on the position of the metering gate 202. The electronic control device 208 is operatively coupled to the actuator 204. The electronic control device 208 is configured to direct the operation of the actuator 204. The electronic control device 208 may typically include a memory device. The memory device may be integrated into the electronic control device 208, may be separate from the electronic control device 208, and/or may be removable from the electronic control device 208. The directed operation of the actuator 204 is based at least in part on the position of the metering gate 202 as indicated by the sensor 206.

In alternate embodiments, as with other components described herein, metering gate 202 is shown as a singular element but may be provided in plural. In other alternate embodiments, the metering gate 202 may include multiple telescoping segments, for example. In this exemplary embodiment, the metering gate 202 slides in the direction of arrows 250 and 252. In alternate embodiments, the metering gate 202 may rotate, for example.

In this illustrative embodiment, the actuator 204 is a hydraulic cylinder. In alternate embodiments, the actuator 204 may be an electric linear actuator, for example. In alternate embodiments, the actuator 204 may be a hydraulic linear actuator, for example. In alternate embodiments, the actuator 204 may include a hydraulic motor and a rack and pinion, where the hydraulic motor may rotate a circular gear which is coupled to a linear gear attached to the metering gate 202, for example. In alternate embodiments, the actuator 204 may include an electric motor and a rack and pinion, where the electric motor may rotate a circular gear which is coupled to a linear gear attached to the metering gate 202, for example. The actuator 204 may be a combination of elements configured to position the metering gate 202.

In this illustrative embodiment, the sensor 206 is coupled to the actuator 204. In alternate embodiments, the sensor 206 may not be coupled to the actuator 204. In some embodiments, the sensor 206 may be configured to detect at least a portion of the metering gate 202. In alternate embodiments, the sensor may be a time-of-flight sensor, for example. In some embodiments, the sensor 206 may be a pressure transducer configured to measure the hydraulic fluid pressure of hydraulic created during the movement of the metering gate 202, for example. In alternate embodiments, the sensor 206 may be a plurality of proximity or hall effect sensors configured to measure specific intervals of metering gate positions, for example. The plurality of proximity or hall effect sensors may be arranged in series and configured to measure specific intervals of metering gate positions, for example. The sensor 206 may be a combination of elements configured to detect the position of the metering gate 202. In some embodiments, as with other components described herein, there may be multiple metering gates 202, and some metering gates 202 may not have a corresponding sensor 206.

In this exemplary embodiment, the actuator 204 is a hydraulic cylinder. A hydraulic valve 210 operatively couples the actuator 204 and a tractor’s hydraulic remote connections 140. The hydraulic valve 210 is operatively coupled to the tractor’s hydraulic remote connections 140 through hydraulic lines or hoses 218, for example. The hydraulic valve 210 is operatively coupled to the actuator 204 through hydraulic lines or hoses 220, for example. In this exemplary embodiment, the sensor 206 provides a metering gate position value to the electronic control device 208. The electronic control device 208 controls an output to the hydraulic valve 210 to control the hydraulic fluid to the actuator 204 to control the position of the metering gate 202.

Referring to FIGS. 1-6, the gate positioning system 200 may include a user interface 212. The user interface 212 is operatively coupled to the electronic control device 208. The user interface 212 may be used by an operator to set a flow rate of the grain 102 going to the transfer element 130. Setting a flow rate may program the electronic control device 208 to control the flow rate of the grain 102. In some instances, the user interface 212 may be used by an operator to set a maximum flow rate of the grain 102 going to the transfer element 130. Setting a maximum flow rate may program the electronic control device 208 to control the flow rate of the grain 102 at or below the maximum flow rate. In some embodiments, the user interface 212 may be used by an operator to set and/or control the flow rate of the grain 102 going to the transfer element 130 during grain unloading.

Alternatively, the user interface 212 may be used by an operator to set a metering gate position, thereby setting a flow rate of the grain 102 going to the transfer element 130. Setting a metering gate position may program the electronic control device 208 to control the position of the metering gate 202. In some instances, the user interface 212 may be used by an operator to set a maximum metering gate open position, thereby setting a maximum flow rate of the grain 102 going to the transfer element 130. Setting a maximum metering gate open position may program the electronic control device 208 to control the flow rate of the grain 102 at or below the maximum metering gate open position. In some embodiments, the user interface 212 may be used by an operator to set and/or control the position of the metering gate 202 during grain unloading.

Referring to FIGS. 5 and 6, in some embodiments, the user interface 212 may be a graphical user interface. In alternate embodiments, the user interface 212 may be a combination of switches, dials, push buttons, screws, and/or slide controls. In some embodiments, the user interface 212 may be a multi-positional dial (e.g., potentiometer). In alternate embodiments, the user interface 212 may be a selector switch. The user interface 212 may include perceptible indicators. Perceptible indicator may include visual indicators, lamps for example, and/or audible indicators, audible alarms for example. The user interface 212 may be located in a tractor cab, for example.

In alternative or additional aspects, the gate positioning system 200 may include a transmitter 214 and a receiver 216. The user interface 212 may be operatively coupled to both a transmitter 214 and a receiver 216, and the electronic control device 208 may be operatively coupled to both a transmitter 214 and a receiver 216 allowing the user interface 212 and the electronic control device 208 to communicate wirelessly. Utilizing a transmitter 214 and a receiver 216, the user interface 212 may be easily relocated from one tractor cab to another tractor cab, for example. Utilizing a transmitter 214 and a receiver 216, the user interface 212 may be used by an operator while the operator is standing beside a grain cart 100, for example.

Again, referring to FIGS. 1-5, for a user to operate the gate positioning system 200, in this illustrative example, a grain cart 100 may be prepared for use by coupling the grain cart 100 to a tractor 124 using a hitch 230. The grain cart’s power takeoff connection 232, which drives the transfer element 130, may be coupled to the tractor’s power takeoff. Hydraulic hoses 218 may be connected between the tractor 124 and the grain cart 100. An operational input, such as a maximum metering gate open position, may be programed into the electronic control device 208. A user may set an operational input, such as a maximum metering gate open position, using the user interface 212. After starting the transfer element 130, which starts unloading grain 102 from the supplying container 132, (e.g., the grain cart grain tank 120), the user may control the opening and closing of the metering gate 202 using the user interface 212, for example. Based at least in part on the operational input to the user interface 212, the electronic control device 208 may send a signal to the hydraulic valve 210 controlling the flow of hydraulic fluid to the actuator 204 thereby controlling the movement of the metering gate 202. If the metering gate 202 is open less than the maximum metering gate open position, the user may open the metering gate 202 up to the maximum metering gate open position. During grain unloading, the sensor 206 may provide an operational input, such as positional feedback, to the electronic control device 208. If the sensor 206 senses the metering gate 202 is open equal to the user’s maximum metering gate open position, the electronic control device 208 may send a signal to the hydraulic valve 210 stopping the flow of hydraulic fluid to the actuator 204 thereby stopping the movement of the metering gate 202, for example. At any time, the user may close the metering gate 202 using the user interface 212, for example. If the user desires to increase or decrease the maximum metering gate open position during unload operations, the user may adjust the maximum metering gate open position with the user interface 212, for example.

Alternatively, an operational input, such as a metering gate open position, may be programed into the electronic control device 208. A user may set an operational input, such as a metering gate open position, using the user interface 212, for example. After starting the transfer element 130, based at least in part on the operational input, the electronic control device 208 may send a signal to the hydraulic valve 210 controlling the flow of hydraulic fluid to the actuator 204 thereby controlling the movement of the metering gate 202 to match the user set metering gate open position, for example. During grain unloading, the sensor 206 may provide an operational input, such as positional feedback, to the electronic control device 208. If the sensor 206 senses the metering gate 202 is not at the user set metering gate open position, the electronic control device 208 may send a signal to the hydraulic valve 210 controlling the flow of hydraulic fluid to the actuator 204 thereby controlling the movement of the metering gate 202 to match the user set metering gate open position, for example. At any time, the user may close the metering gate 202 using the user interface 212, for example. In some embodiments, if the user desires to increase or decrease the set metering gate open position during grain unloading, the user may set a new metering gate open position with the user interface 212, for example. In some embodiments, if the user desires to increase or decrease the set metering gate open position during grain unloading, the user may adjust the metering gate open position with the user interface 212 and the metering gate open position may become the set metering gate open position, for example.

In some embodiments, a user may set the metering gate position by selecting a metering gate position from a plurality of preset metering gate positions through a user interface 212 that may include the plurality of metering gate positions, for example. In some embodiments, a user may change the metering gate position during grain unloading by selecting the metering gate position from the plurality of preset metering gate positions through the user interface 212, for example.

In some embodiments, an operational input, such as a maximum unloading rate, may be programed into the electronic control device 208. A user may set an operational input, such as a maximum unloading rate, with a user interface 212. The electronic control device 208 may determine the maximum metering gate open position required to achieve the maximum unloading rate, for example. After starting the transfer element 130, which starts unloading grain 102 from the supplying container 132, (e.g. grain cart grain tank 120), the user may control the unloading rate using the user interface 212, for example. Based at least in part on the operational input, the electronic control device 208 may send a signal to the hydraulic valve 210 controlling the flow of hydraulic fluid to the actuator 204 thereby controlling the movement of the metering gate 202 thereby controlling the unloading rate. If the unloading rate is less than the maximum unloading rate, the user may control the unloading rate up to the maximum unloading rate. During unloading, the sensor 206 may provide an operational input, such as positional feedback, to the electronic control device 208. If the sensor 206 senses the metering gate 202 is open equal to what is required to achieve the maximum unloading rate, the electronic control device 208 may send a signal to the hydraulic valve 210 stopping the flow of hydraulic fluid to the actuator 204 thereby stopping the movement of the metering gate 202, for example. At any time, the user may close the metering gate 202 with the user interface 212, for example. If the user desires to increase or decrease the maximum unloading rate during unloading, the user may adjust the maximum unloading rate with the user interface 212.

In some embodiments, an operational input, such as an unloading rate, may be programed into the electronic control device 208. A user may set an operational input, such as an unloading rate, with the user interface 212. The electronic control device 208 may determine the metering gate position required to achieve the unloading rate, for example. After starting the transfer element 130, which starts unloading grain 102 from the supplying container 132, (e.g. grain cart grain tank 120), the user may control the unloading rate using the user interface 212, for example. Based at least in part on the operational input, the electronic control device 208 may send a signal to the hydraulic valve 210 controlling the flow of hydraulic fluid to the actuator 204 thereby controlling the movement of the metering gate 202 thereby controlling the unloading rate. During grain unloading, the sensor 206 may provide an operational input, such as positional feedback, to the electronic control device 208. If the sensor 206 senses the metering gate 202 is not open equal to the position required to achieve the unloading rate set by the user, the electronic control device 208 may send a signal to the hydraulic valve 210 to control the flow of hydraulic fluid to the actuator 204 thereby controlling the movement and thereby the position of the metering gate 202, for example. At any time, the user may close the metering gate 202 with the user interface 212, for example. If the user desires to increase or decrease the unloading rate during unloading, the user may adjust the unloading rate with the user interface 212, for example.

In some embodiments, a user may enter the rate at which grain 102 is unloaded from a grain cart 100 by selecting an unload rate from a plurality of preset unload rates through a user interface 212 that may include the plurality of unload rates, for example. In some embodiments, a user may change the rate at which grain 102 is unloaded from a grain cart 100 during unloading by selecting an unload rate from a plurality of preset unload rates through a user interface 212 that may include the plurality of unload rates, for example.

The gate positioning system 200 may allow multiple operators with different skill levels to confidently control the grain unloading of the grain cart 100, for example. The gate positioning system 200 may also allow for quick and efficient changes to the system during grain unloading, for example. Additionally, the gate positioning system 200 may reduce the time required for the user to find a comfortable unload rate by stopping the metering gate 202 automatically at the desired unload rate with a preset.

In some embodiments, the gate positioning system 200 may include a cleanout mode. For example, near the end of an unload cycle, the electronic control device 208 may position the metering gate 202 fully open, regardless of the user selected value, to enhance discharging all of the grain 102 from the grain cart grain tank 120.

Farm equipment, including tractors and grain carts with unloading augers, may include torque limiting devices to prevent damage to the equipment. In some applications, the unload rate may be controlled by controlling the rotational speed of a transfer element 130, such as an auger for example. As the rotational speed of an auger, for example, decreases the operational torque may increase and a torque limiting device on the unloading system may be triggered. Utilizing the gate positioning system 200, the unload rate may be controlled by the metering gate 202, and not the rotational speed of the transfer element 130, an auger for example. The grain cart auger or augers may be operated at an optimal rotational speed, thereby minimizing the operational torque and stresses on the grain cart unloading system and minimizing the chance that a torque limiting device on the unloading system will be triggered. Similarly, if a torque limiting device on the unloading system were to be triggered due to specific operating conditions, the gate positioning system 200 may allow an operator to reduce the maximum operating torque by limiting the maximum metering gate opening. Alternatively, if a torque limiting device on the unloading system were to be triggered due to specific operating conditions, the gate positioning system 200 may automatically limit the maximum metering gate opening to reduce the maximum operating torque.

Some torque limiting devices generally include a friction clutch generally comprising two plates, a friction material located between the two plates, and plurality of springs to draw the plates together and apply pressure to the friction material, for example. Under normal operating conditions, a torque limiting device transfers power by coupling two shafts such that the coupled shafts rotate as a single unit. When a torque limiting device is activated the plates and friction material will rotate in relation to one another and the mating surfaces will slide against one another generating heat and causing the mating surfaces to wear, for example. If a torque limiting device is repeatedly activated or activated for an extended period of time, the torque limiting device may be damaged and may need to be repaired or replaced.

In alternative or additional aspects, the gate positioning system 200 may be configured to prevent the torque applied to the transfer element 130, an auger for example, from exceeding a maximum torque value. If the torque applied to the transfer element 130, an auger for example, exceeds a maximum torque value, a torque limiting device may be activated to prevent damage to the unloading system. The gate positioning system 200 may include a torque sensor 234 coupled to the electronic control device 208. The torque sensor 234 may be configured to detect a torque applied to the transfer element 130 and provide an operational input to the electronic control device 208. The torque sensor 234 may be a strain gauge installed on the driveline configured to determine the operational torque of the unloading system, for example. The electronic control device 208 may be programed to control the position of the metering gate 202 to control the torque applied to the transfer element 130. A maximum torque value may be programed into the electronic control device 208. The electronic control device 208 may include a plurality of pre-programed maximum torque values and a pre-programed maximum torque value may be selected, for example. The electronic control device 208 may monitor the torque applied to the transfer element 130 and the electronic control device 208 may control the position of the metering gate 202 to control the torque applied to the transfer element 130 at or below the programed maximum torque value. The electronic control device 208 may be programed to control the position of the metering gate 202 to maintain a torque applied to the transfer element 130, an auger for example, at or near a programed torque. The electronic control device 208 may be programed to control the position of the metering gate 202 to maintain a torque applied to the transfer element 130, an auger for example, within a torque range. Minimum and maximum torque values may be programed into the electronic control device 208, for example. The electronic control device 208 may include a plurality of pre-programed minimum and maximum torque values and pre-programed minimum and maximum torque values may be selected, for example. The electronic control device 208 may monitor the torque applied to the transfer element 130 and the electronic control device 208 may control the position of the metering gate 202 to maintain the torque applied to the transfer element 130 between the programed minimum and maximum torque values.

A minimum torque value may be an indication that there is little or no grain 102 in the transfer element 130, for example. The electronic control device 208 may close the metering gate 202 if the detected torque is below a minimum torque value. Automatically closing the metering gate 202 based on a detected torque value may save the operator the additional step of closing the metering gate 202 after grain unloading is complete, for example. The electronic control device 208 may provide a perceptible indication that the metering gate 202 has been closed. The perceptible indication could be an audible alarm, for example. The perceptible indication could be an indicator light, for example. The perceptible indication could be message on a graphical user interface, for example.

In alternative embodiments, the gate positioning system 200 may be configured to maintain a minimum rotational speed of the transfer element 130, an auger for example. If the transfer element 130 is driven by a tractor power take off for example, and the rotational speed of the transfer element 130 falls below a minimum value, the tractor engine may stall, for example. Further, as the rotational speed of an auger, for example, decreases the operational torque on the unloading system may increase. The gate positioning system 200 may include a rotational speed sensor 236 coupled to the electronic control device 208. The rotational speed sensor 236 may be configured to detect the rotational speed of the transfer element 130 and provide an operational input to the electronic control device 208. The electronic control device 208 may be programed to control the position of the metering gate 202 to control the rotational speed of the transfer element 130. A minimum rotational speed value may be programed into the electronic control device 208. The electronic control device 208 may include a plurality of pre-programed minimum rotational speed values and a pre-programed minimum rotational speed value may be selected. The electronic control device 208 may monitor the rotational speed of the transfer element 130 and the electronic control device 208 may control the position of the metering gate 202 to maintain the rotational speed of the transfer element 130 at or above the programed minimum rotational speed. The electronic control device 208 may be programed to control the position of the metering gate 202 to maintain the rotational speed of the transfer element 130, an auger for example, at or near a programed rotational speed. The electronic control device 208 may be programed to control the position of the metering gate 202 to maintain the rotational speed of the transfer element 130, an auger for example, within a rotational speed range. Minimum and maximum rotational speed values may be programed into the electronic control device 208. The electronic control device 208 may include a plurality of pre-programed minimum and maximum rotational speed values and pre-programed minimum and maximum rotational speed values may be selected, for example. The electronic control device 208 may monitor the rotational speed of the transfer element 130 and the electronic control device 208 may control the position of the metering gate 202 to maintain the rotational speed of the transfer element 130 between the minimum and maximum programed rotational speeds, for example.

A rotational speed of zero may be an indication that grain unloading is complete, for example. A rotational speed of zero may be an indication that tractor engine has stalled or been shut off, for example. The electronic control device 208 may close the metering gate 202 if the detected rotational speed is zero. Automatically closing the metering gate 202 based on a detected rotational speed of zero may save the operator the additional step of closing the metering gate 202 after grain unloading is complete, for example. The electronic control device 208 may provide a perceptible indication that the metering gate 202 has been closed. The electronic control device 208 may be configured to not open the metering gate 202 if the detected rotational speed is below a minimum value, for example. The electronic control device 208 may provide a perceptible indication that the electronic control device 208 will not open the metering gate 202 due to low rotational speed. An operator may be alerted to increase the speed of the tractor’s power takeoff, for example. The perceptible indication could be an audible alarm, for example. The perceptible indication could be an indicator light, for example. The perceptible indication could be message on a graphical user interface, for example.

In alternative or additional aspects, the gate positioning system 200 may be configured to control the horsepower applied to the transfer element 130, an auger for example. The gate positioning system 200 may include a torque sensor 234 coupled to the electronic control device 208. The torque sensor 234 may be configured to detect a torque applied to the transfer element 130, for example. The torque sensor 234 may be a strain gauge installed on the driveline configured to determine the operational torque of the unloading system, for example. The gate positioning system 200 may include a rotational speed sensor 236 coupled to the electronic control device 208. The rotational speed sensor 236 may be configured to detect the rotational speed of the transfer element 130, for example. The torque sensor 234 and the speed sensor 236 may provide an operational input to the electronic control device 208. The detected torque and the detected rotational speed may define a horsepower applied to the transfer element 130, for example. The electronic control device 208 may calculate the horsepower applied to the transfer element 130 based on an operational input, for example. Alternately, the horsepower applied to the transfer element 130 may be detected by a single sensor, for example. The electronic control device 208 may be programed to control the position of the metering gate 202 to control the horsepower applied to the transfer element 130. A horsepower value may be programed into the electronic control device 208. A minimum and/or a maximum horsepower value may be programed into the electronic control device 208. The electronic control device 208 may include a plurality of pre-programed horsepower values and a pre-programed horsepower value may be selected. A plurality of pre-programed horsepower values may be selected defining a minimum horsepower value and a maximum horsepower value, for example. The electronic control device 208 may monitor the horsepower applied to the transfer element 130. The electronic control device 208 may control the position of the metering gate 202 to control the horsepower applied to the transfer element 130 at or near a programed horsepower value. The electronic control device 208 may control the position of the metering gate 202 to control the horsepower applied to the transfer element 130 at or above a programed minimum horsepower value. The electronic control device 208 may control the position of the metering gate 202 to control the horsepower applied to the transfer element 130 at or below a programed maximum horsepower value. The maximum horsepower may be set below a maximum operating horsepower of the tractor 124 so as not to stall the tractor engine, for example. The electronic control device 208 may control the position of the metering gate 202 to maintain the horsepower applied to the transfer element 130 between a programed minimum horsepower value and a programed maximum horsepower value.

In alternative or additional aspects, the gate positioning system 200 may be configured to control the rate at which grain 102 is unloaded from a supplying container 132, such as a grain cart grain tank 120, by incorporating a weigh scale 238 coupled to the grain cart 100, for example. The weigh scale 238 may be configured to detect the weight of the grain 102 in the grain cart grain tank 120. The weigh scale 238 may provide an operational input to the electronic control device 208 to assist with controlling the unload rate. A transfer rate may be programed into the electronic control device 208. The electronic control device 208 may be configured to direct the operation of the actuator 204 and the directed operation of the actuator 204 may be based at least in part on the programed transfer rate and the weight of the grain 102 in the grain cart grain tank 120. The electronic control device 208 may monitor the weight of the grain 102 in the grain cart grain tank 120 and the electronic control device 208 may control the position of the metering gate 202 to maintain the unload rate at or near the programed transfer rate.

As described herein, examples of operational inputs may include any combination of user and/or programed inputs such as metering gate position, unloading rate, torque, rotational speed, and horsepower, or may include one or more of any other desired user and/or programed inputs. It is to be understood, user and/or programed inputs are not limited to metering gate position, unloading rate, torque, rotational speed, and horsepower. Additional examples of operational inputs may include any combination of sensor inputs such as metering gate position, torque, rotational speed, horsepower, and weight, or may include one or more of any other desired sensor inputs. It is to be understood, operational inputs are not limited to sensor inputs such as metering gate position, torque, rotational speed, horsepower, and weight. It should be appreciated by one of ordinary skill in the art that any operational input that may be used to control the position of a metering gate 202 may be employed.

A method of operating a gate positioning system 200 may include operating a transfer element 130 at a desired unloading rate. A sensor may provide an operational input to an electronic control device 208. The electronic control device 208 may be configured to direct the operation of an actuator 204 coupled to a metering gate 202. The metering gate 202 may be configured to be positioned to control a flow of grain 102 from a supplying container 132 to a transfer element 130. The operational input may include metering gate position, torque, rotational speed, horsepower, and weight, or any combination thereof. The electronic control device 208 may control the position of the metering gate 202 based at least in part on the sensor input to maintain the unloading rate at or near the desired unloading rate.

Although FIGS. 1-6 and the corresponding description focus on the use of the gate positioning system 200 in connection with transferring grain 102 from the grain cart 100 to the grain hopper trailer 126, it will be appreciated that generally similar operations may be utilized when transferring other agricultural materials between other types of equipment, such as generally from any supplying container 132 to any receiving container 134.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

1. A device for controlling the rate at which agricultural material is unloaded from a supplying container, the device comprising:
a metering gate configured to control the flow of agricultural material from the supplying container to a transfer element;
an actuator coupled to the metering gate and configured to move the metering gate between an open position and a closed position;
an electronic control device coupled to the actuator and configured to direct the operation of the actuator; and
a sensor configured to detect a position of the metering gate and provide an operational input to the electronic control device;
wherein a maximum open position of the metering gate is programmable into the electronic control device,
the directed operation of the actuator is based at least in part on the programmed maximum open position of the metering gate and the position of the metering gate, and
the transfer element is configured to transfer agricultural material from the supplying container to a receiving container.

2. The device of claim 1, wherein the electronic control device monitors the position of the metering gate, and
the electronic control device controls the position of the metering gate to limit the position of the metering gate at or below the programmed maximum open position.

3. The device of claim 1, wherein the electronic control device comprises a plurality of pre-programmed metering gate maximum open positions.

4. The device of claim 3, wherein at least one of the pre-programmed metering gate maximum open positions may be selected,
the electronic control device monitors the position of the metering gate, and
the electronic control device controls the position of the metering gate to limit the position of the metering gate at or below the programmed maximum open position.

5. A device for controlling the rate at which agricultural material is unloaded from a supplying container, the device comprising:
a metering gate configured to control the flow of agricultural material from the supplying container to a transfer element;
an actuator coupled to the metering gate and configured to move the metering gate between an open position and a closed position;
an electronic control device coupled to the actuator and configured to direct the operation of the actuator; and
a sensor configured to detect a position of the metering gate and provide an operational input to the electronic control device;
wherein a maximum transfer rate is programmable into the electronic control device,
the directed operation of the actuator is based at least in part on the programmed maximum transfer rate and the position of the metering gate, and
the transfer element is configured to transfer agricultural material from the supplying container to a receiving container.

6. The device of claim 5, wherein the electronic control device monitors the position of the metering gate, and
wherein the electronic control device controls the position of the metering gate to maintain the unload rate at or below the programmed maximum transfer rate.

7. The device of claim 5, wherein the electronic control device comprises a plurality of pre-programmed maximum transfer rates.

8. The device of claim 7, wherein one of the pre-programmed maximum transfer rates may be selected,
the electronic control device monitors the position of the metering gate, and
the electronic control device controls the position of the metering gate to maintain the unload rate at or below the programmed maximum transfer rate.

9. The device of claim 5, wherein the electronic control device comprises a cleanout mode,
wherein when the device is in cleanout mode the electronic control device controls the position of the metering gate and positions the metering gate in a fully open position.

10. The device of claim 5, further comprising a user interface coupled to the electronic control device,
wherein the user interface is operative to allow a user to program an operational input into the electronic control device.

11. The device of claim 10, wherein the user interface comprises a graphical user interface.

12. The device of claim 10, wherein the user interface is wirelessly coupled to the electronic control device.

13. The device of claim 5, wherein the actuator comprises a hydraulic cylinder.

14. The device of claim 13, wherein the hydraulic cylinder further comprises the sensor.

15. The device of claim 13, further comprising a hydraulic valve,
wherein the electronic control device is configured to control a hydraulic valve, and
the hydraulic valve is configured to control the flow of hydraulic fluid to the hydraulic cylinder to control the position of the metering gate.

16. The device of claim 5, wherein the actuator comprises an electric linear actuator.

17. The device of claim 16, wherein the electric linear actuator further comprises the sensor.

18. The device of claim 5, wherein the actuator comprises a hydraulic linear actuator.

19. The device of claim 18, wherein the hydraulic linear actuator further comprises the sensor.

20. The device of claim 5, wherein the sensor comprises a linear position sensor.

21. The device of claim 5, wherein the sensor comprises a time-of-flight sensor.

22. The device of claim 5, wherein the sensor comprises a pressure transducer.

23. The device of claim 5, wherein the sensor comprises a plurality of proximity sensors.

24. The device of claim 5, further comprising a second sensor coupled to the electronic control device,
wherein the second sensor is configured to detect a torque applied to the transfer element,
wherein the second sensor provides an operational input to the electronic control device, and
wherein the directed operation of the actuator is based at least in part on the torque applied to the transfer element.

25. The device of claim 24, wherein the electronic control device controls the position of the metering gate to limit the torque applied to the transfer element below a maximum torque.

26. The device of claim 24, wherein a maximum torque value may be programmed into the electronic control device.

27. The device of claim 26, wherein the electronic control device comprises a plurality of pre-programmed maximum torque values.

28. The device of claim 27, wherein one of the pre-programmed maximum torque values may be selected,
the electronic control device monitors the torque applied to the transfer element, and
the electronic control device controls the position of the metering gate to limit the torque applied to the transfer element at or below the programmed maximum torque value.

29. The device of claim 24, wherein the electronic control device closes the metering gate if the detected torque is below a minimum torque value.

30. The device of claim 29, further comprising a perceptible indication that the metering gate has been closed.

31. The device of claim 5, further comprising a second sensor coupled to the electronic control device,
wherein the second sensor is configured to detect a rotational speed of the transfer element,
wherein the second sensor provides an operational input to the electronic control device, and
wherein the directed operation of the actuator is based at least in part on the rotational speed of the transfer element.

32. The device of claim 31, wherein the electronic control device controls the position of the metering gate to maintain a minimum rotational speed of the transfer element.

33. The device of claim 31, wherein a minimum rotational speed value may be programmed into the electronic control device.

34. The device of claim 33, wherein the electronic control device comprises a plurality of pre-programmed minimum rotational speed values.

35. The device of claim 34, wherein one of the pre-programmed minimum rotational speed values may be selected,
the electronic control device monitors the rotational speed of the transfer element; and
the electronic control device controls the position of the metering gate to maintain the rotational speed of the transfer element at or above the programmed minimum rotational speed.

36. The device of claim 31, wherein the electronic control device closes the metering gate if the detected rotational speed is zero.

37. The device of claim 36, further comprising a perceptible indication that the metering gate has been closed.

38. The device of claim 31, wherein the electronic control device will not open the metering gate if the detected rotational speed is below a minimum value.

39. The device of claim 38, further comprising a perceptible indication that the metering gate electronic control device will not open the metering gate.

40. The device of claim 5, further comprising a second sensor configured to detect a horsepower applied to the transfer element and coupled to the electronic control device,
wherein the second sensor provides an operational input to the electronic control device, and
wherein the directed operation of the actuator is based at least in part on the horsepower applied to the transfer element.

41. The device of claim 40, wherein the electronic control device controls the position of the metering gate to control the horsepower applied to the transfer element.

42. The device of claim 40, wherein a maximum horsepower value may be programmed into the electronic control device.

43. The device of claim 42, wherein the electronic control device comprises a plurality of pre-programmed horsepower values.

44. The device of claim 43, wherein one of the pre-programmed maximum horsepower values may be selected,
the electronic control device monitors the horsepower applied to the transfer element, and
the electronic control device controls the position of the metering gate to control the horsepower applied to the transfer element at or below the programmed maximum horsepower value.

45. A device for controlling the rate at which agricultural material is unloaded from a supplying container, the device comprising:
a metering gate configured to control the flow of agricultural material from the supplying container to a transfer element;
an actuator coupled to the metering gate and configured to move the metering gate between an open position and a closed position;
an electronic control device coupled to the actuator and configured to direct the operation of the actuator; and
a sensor configured to detect a position of the metering gate and provide an operational input to the electronic control device;
wherein a transfer rate is programmable into the electronic control device,
the directed operation of the actuator is based at least in part on the programmed transfer rate and the position of the metering gate, and
the transfer element is configured to transfer agricultural material from the supplying container to a receiving container.

46. The device of claim 45, wherein the electronic control device monitors the position of the metering gate, and
the electronic control device controls the position of the metering gate to maintain the unload rate at or near the programmed transfer rate.

47. A device for controlling the rate at which agricultural material is unloaded from a supplying container, the device comprising:
a metering gate configured to control the flow of agricultural material from the supplying container to a transfer element;
an actuator coupled to the metering gate and configured to move the metering gate between an open position and a closed position;
an electronic control device coupled to the actuator and configured to direct the operation of the actuator; and
a sensor configured to detect a torque applied to the transfer element and provide an operational input to the electronic control device;
wherein a transfer rate is programmable into the electronic control device,
the directed operation of the actuator is based at least in part on the programmed transfer rate and the torque applied to the transfer element, and
the transfer element is configured to transfer agricultural material from the supplying container to a receiving container.

48. The device of claim 47, wherein the electronic control device monitors the torque applied to the transfer element, and
the electronic control device controls the position of the metering gate to maintain the unload rate at or near the programmed transfer rate.

49. A device for controlling the rate at which agricultural material is unloaded from a supplying container, the device comprising:
a metering gate configured to control the flow of agricultural material from the supplying container to a transfer element;
an actuator coupled to the metering gate and configured to move the metering gate between an open position and a closed position;
an electronic control device coupled to the actuator and configured to direct the operation of the actuator; and
a sensor configured to detect a speed of the transfer element and provide an operational input to the electronic control device;
wherein a transfer rate is programmable into the electronic control device,
the directed operation of the actuator is based at least in part on the programmed transfer rate and the speed of the transfer element, and
the transfer element is configured to transfer agricultural material from the supplying container to a receiving container.

50. The device of claim 49, wherein the electronic control device monitors the speed of the transfer element, and
the electronic control device controls the position of the metering gate to maintain the unload rate at or near the programmed transfer rate.

51. A device for controlling a rate at which agricultural material is unloaded from a supplying container, the device comprising:
a metering gate configured to control the flow of agricultural material from the supplying container to a transfer element;
an actuator coupled to the metering gate and configured to move the metering gate between an open position and a closed position;
an electronic control device coupled to the actuator and configured to direct the operation of the actuator; and
a weigh scale configured to detect a weight of agricultural material in the supplying container and provide an operational input to the electronic control device;
wherein a transfer rate is programmable into the electronic control device,
the directed operation of the actuator is based at least in part on the programmed transfer rate and the weight of the agricultural material in the supplying container, and
the transfer element is configured to transfer agricultural material from the supplying container to a receiving container.

52. The device of claim 51, wherein the electronic control device monitors the weight of the agricultural material in the supplying container, and
the electronic control device controls the position of the metering gate to maintain the unload rate at or near the programmed transfer rate.

53. A device for controlling a rate at which agricultural material is unloaded from a supplying container, the device comprising:
a metering gate configured to control the flow of agricultural material from the supplying container to a transfer element;
an actuator coupled to the metering gate and configured to move the metering gate between an open position and a closed position;
an electronic control device coupled to the actuator and configured to direct the operation of the actuator; and
a sensor configured to detect a horsepower applied to the transfer element and provide an operational input to the electronic control device;
wherein a transfer rate is programmable into the electronic control device,
the directed operation of the actuator is based at least in part on the programmed transfer rate and the horsepower applied to the transfer element, and
the transfer element is configured to transfer agricultural material from the supplying container to a receiving container.

54. The device of claim 53, wherein the electronic control device monitors the horsepower applied to the transfer element, and
the electronic control device controls the position of the metering gate to maintain the unload rate at or near the programmed transfer rate.

55. A method of operating a gate positioning system, the method comprising:
programming a maximum metering gate open position into an electronic control device,
operating a transfer element,
opening a metering gate;
providing information on an open state of the metering gate to the electronic control device, and
preventing the metering gate from opening past the programmed maximum metering gate open position.

56. The method of claim 55, further comprising changing the maximum metering gate open position during an unload operation.

57. The method of claim 55, further comprising selecting a maximum metering gate open position from a plurality of preprogrammed metering gate open positions.

58. The method of claim 57, further comprising changing the maximum metering gate open position during an unload operation by selecting a new maximum metering gate open position from a plurality of pre-programmed metering gate open positions.

59. The method of claim 55, further comprising programming a maximum unloading rate to program a maximum metering gate open position.

60. The method of claim 59, further comprising determining the metering gate position required to achieve the maximum unloading rate.

61. The method of claim 59, further comprising selecting a maximum unload rate from a plurality of pre-programmed unload rates.

62. The method of claim 59, further comprising changing a maximum unloading rate during an unload operation by selecting an unload rate from a plurality of preset unload rates.

63. The method of claim 55, further comprising performing a cleanout by positioning the metering gate in a fully open position.

64. The method of claim 55, further comprising closing the metering gate.

65. The method of claim 55, further comprising: coupling a grain cart to a tractor, and
coupling a power and hydraulic lines between the grain cart and the tractor.

66. A method of manufacturing a gate positioning system, the method comprising:
installing a metering gate on a supplying container, wherein the metering gate is configured to be positioned to control the flow of agricultural material from the supplying container to a transfer element;
installing an actuator for positioning the metering gate, wherein the actuator is coupled to the metering gate;
installing a sensor configured to detect the position of the metering gate; and
installing an electronic control device coupled to the sensor and the actuator;
wherein the electronic control device is configured to direct the operation of the actuator,
a maximum open position of the metering gate may be programmed into the electronic control device,
the directed operation of the actuator is based at least in part on the programmed maximum open position of the metering gate and the position of the metering gate detected by the sensor, and
the transfer element is configured to transfer agricultural material from the supplying container to a receiving container.

67. A method of manufacturing a gate positioning system, the method comprising:
installing a metering gate on a supplying container, wherein the metering gate is configured to be positioned to control the flow of agricultural material from the supplying container to a transfer element;
installing an actuator for positioning the metering gate, wherein the actuator is coupled to the metering gate;
installing a sensor configured to detect the position of the metering gate; and
installing an electronic control device coupled to the sensor and the actuator;
wherein the electronic control device is configured to direct the operation of the actuator,
a maximum transfer rate may be programmed into the electronic control device,
the directed operation of the actuator is based at least in part on the programmed transfer rate and the position of the metering gate detected by the sensor, and
the transfer element is configured to transfer agricultural material from the supplying container to a receiving container.

68. A device for controlling the rate at which agricultural material is unloaded from a supplying container, the device comprising:
a metering gate configured to control the flow of agricultural material from the supplying container to a transfer element;
an actuator coupled to the metering gate and configured to move the metering gate between an open position and a closed position;
an electronic control device coupled to the actuator and configured to direct the operation of the actuator; and
a sensor configured to detect an operating condition and provide an operational input to the electronic control device;
wherein the directed operation of the actuator is based at least in part on the operational input, and
the transfer element is configured to transfer agricultural material from the supplying container to a receiving container.

69. The device of claim 68, wherein the operating condition is a position of the metering gate, and
the sensor comprises a sensor configured to detect the position of the metering gate.

70. The device of claim 68, wherein the operating condition is a torque applied to the transfer element, and
the sensor comprises a sensor configured to detect the torque applied to the transfer element.

71. The device of claim 68, wherein the operating condition is a rotational speed of the transfer element, and
the sensor comprises a sensor configured to detect the rotational speed of the transfer element.

72. The device of claim 68, wherein the operating condition is a horsepower applied to the transfer element, and
the sensor comprises a sensor configured to detect the horsepower applied to the transfer element.

73. The device of claim 68, wherein the operating condition is a weight of agricultural material in the supplying container, and
the sensor comprises a weigh scale configured to detect the weight of agricultural material in the supplying container.

74. A method of operating a gate positioning system, the method comprising:
operating a transfer element at a desired unloading rate,
utilizing an electronic control device that directs the operation of an actuator coupled to a metering gate,
using a sensor to provide an operational input to the electronic control device,
controlling the position of the metering gate to control a flow of agricultural material from a supplying container to a transfer element, and
maintaining the unloading rate at or near the desired unloading rate based at least in part on the operational input.

75. The method of claim 74, further comprising determining a metering gate position required to maintain the desired unloading rate.

76. The method of claim 74, further comprising determining a required torque applied to the transfer element to maintain the desired unloading rate.

77. The method of claim 74, further comprising determining a required rotational speed of the transfer element to maintain the desired unloading rate.

78. The method of claim 74, further comprising determining a required horsepower applied to the transfer element to maintain the desired unloading rate.

79. The method of claim 74, further comprising monitoring a weight of agricultural material in the supplying container to maintain the desired unloading rate.
